(19) United States
(12) Patent Application Publication
(10) Pub. No.: US 2026/0343269 A1
(43) Pub. Date: Oct. 29, 2026

(54) MECHANISM FOR FAILURE DETECTION

(71) Applicant: Nokia Technologies Oy, Espoo (FI)

(72) Inventors: Yan MENG, Shanghai (CN); Chunli WU, Beijing (CN); Tao TAO, Shanghai (CN); Samuli Heikki TURTINEN, Oulu (FI)

(21) Appl. No.: 19/104,894

(22) PCT Filed: Aug. 22, 2022
(86) PCT No.: PCT/CN2022/114018

§ 371 Date: Feb. 19, 2025

(51) Int. Cl. H04W 24/08; H04L 5/00; H04W 76/18

(52) U.S. Cl. CPC H04W 24/08; H04L 5/0048; H04W 76/18

(57) ABSTRACT

Example embodiments of the present disclosure relate to failure detection. In this solution, a first device receives a reference signal configuration from a second device. The reference signal configuration indicates a set of occasions for monitoring a set of reference signals. The first device also receives information indicating a change in a transmission of the reference signal. The first device performs a predetermined operation associated with a failure detection. For example, if no reference signal is transmitted or a reference signal is transmitted with a reduced transmission power in an occasion from the set of occasions based on the information, the first device may perform the predetermined operation. In this way, it can avoid false alarm of failure declaration. Moreover, it may also avoid false reset of a failure detection counter due to absence of reference signal when the network device determines not to send the reference signal for power saving.

### FIELD

Various example embodiments of the present disclosure generally relate to the field of telecommunication and in particular, to methods, devices, apparatuses and computer readable storage medium for failure detection.

### BACKGROUND

In recent years, energy saving is a hot topic in communication field. For example, a study is on a radio access network which consumes the largest part of total energy consumption in the network and aims at identifying adaptation techniques of transmissions and/or receptions in time, frequency, spatial, and power domains, with potential support/feedback from user equipment (UE), potential UE assistance information, and information exchange/coordination over network interfaces. In addition, beamforming is a signal processing technique that allows a network device sends targeted beams to users, reducing interference and making more efficient use of the frequency spectrum with improved spectral efficiency. When the user is indoor or moving, a radio link between the UE and network device is susceptible to blockage and degradation of radio frequency (RF) signal which can suddenly interrupt the communication link result in beam failure.

### SUMMARY

In a first aspect of the present disclosure, there is provided a first device. The first device comprises at least one processor; and at least one memory storing instructions that, when executed by the at least one processor, cause the first device to perform: receiving, from a second device, a reference signal configuration indicating a set of occasions for monitoring a set of reference signals; receiving, from the second device, information indicating a change in a transmission of a reference signal; and in accordance with a determination that the reference signal is not transmitted or transmitted with a reduced transmission parameter in an occasion from the set of occasions based on the information, performing a predetermined operation associated with a failure detection.

In a second aspect of the present disclosure, there is provided a method. The method comprises: receiving, at a first device and from a second device, a reference signal configuration indicating a set of occasions for monitoring a set of reference signals; receiving, from the second device, information indicating a change in a transmission of a reference signal; and in accordance with a determination that the reference signal is not transmitted or transmitted with a reduced transmission parameter in an occasion from the set of occasions based on the information, performing a predetermined operation associated with a failure detection.

In a third aspect of the present disclosure, there is provided a first apparatus. The first apparatus comprises: means for receiving, from a second device, a reference signal configuration indicating a set of occasions for monitoring a set of reference signals; means for receiving, from the second device, information indicating a change in a transmission of a reference signal; and means for in accordance with a determination that the reference signal is not transmitted or transmitted with a reduced transmission parameter in an occasion from the set of occasions based on the information, performing a predetermined operation associated with a failure detection.

In a fourth aspect of the present disclosure, there is provided a computer readable medium. The computer readable medium comprises instructions stored thereon for causing an apparatus to perform at least the method according to the first aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIG. 3 illustrates a schematic diagram of a reference signal pattern and a discontinuous transmission pattern according to some example embodiments of the present disclosure;

FIG. 4 illustrates a signaling chart for communication according to some example embodiments of the present disclosure;

FIG. 5 illustrates a signaling chart for communication according to some example embodiments of the present disclosure;

FIG. 6 illustrates a signaling chart for communication according to some example embodiments of the present disclosure;

FIG. 7 illustrates a signaling chart for communication according to some example embodiments of the present disclosure;

FIG. 8 illustrates a flowchart of a method implemented at a second device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, it is worth studying power saving at network device. For example, discontinuous transmission (DTX) technique is a promising solution to save network energy by switching on/off radio units (e.g., power amplifier) if there is no transmission to be made. Along with hardware and software capability improvement, the shutdown of the power amplifier on an Orthogonal Frequency Division Multiple (OFDM) symbol basis becomes possible and is commonly applied in commercial networks. Such symbol level discontinuous transmission may be called as micro DTX (μDTX).

In addition, as mentioned above, the radio link between the UE and gNB is susceptible to blockage and degradation of RF signal which can suddenly interrupt the communication link result in Beam Failure. Beam failure detection is a combined layer 1/layer 2 (L1/L2) procedure where L1 (i.e., physical layer (PHY layer)) may provide the medium access control (MAC) layer indications of beam failure instances (BFIs). The MAC layer may count the indications and declares failure when configured maximum number of BFI indications has been reached. So, when the PHY layer detects that the RSRP of the reference signal of the serving beam goes below the threshold, i.e., 10% BLER of a hypothetical PDCCH, it may trigger a Beam failure instance (BFI) and send it to MAC layer. MAC layer may start a timer as soon as it receives BFI, and it may keep incrementing the counter by 1 for every BFI. When a certain threshold of the counter is reached, the MAC layer may trigger Beam Failure and may start the recovery procedure. For example, the counter may be BFI_COUNTER.

When a cell load is low, the cell may want to apply μDTX as much as possible whenever there is no user plane data to be transmitted in a (mini-)slot. However, some pre-configured reference signal (RS) (e.g., periodic channel state information reference signal (CSI-RS)) transmissions may interrupt a cell “sleeping” period. If these transmissions are not urgent, the gNB would prefer to skip or delay them, in order to save more energy.

However, such operation (i.e., skipping periodic CSI-RS) may have impact on beam management operation. In some solutions, the UE may monitor downlink quality based on configured beam failure detection reference signal (BFD-RS) and assess the downlink radio link quality per every evaluation period. However, if the gNB applies uDTX, the DL reference signal transmission may be interrupted if the occasion of RS transmission overlaps with a DTX period, which may lead to unnecessary beam failure.

According to some example embodiments of the present disclosure, there is provided a solution for failure detection. In this solution, a first device receives a reference signal configuration from a second device. The reference signal configuration indicates a set of occasions for monitoring a reference signal. The first device also receives information indicating a change in a transmission of the reference signal. The first device performs a predetermined operation associated with a failure detection. For example, if no reference signal is transmitted or a reference signal is transmitted with a reduced transmission power in an occasion from the set of occasions based on the information, the first device may perform the predetermined operation. In this way, it can avoid false alarm of failure declaration. Moreover, it may also avoid false reset of a failure detection counter due to absence of reference signal when the network device determines not to send the reference signal for power saving.

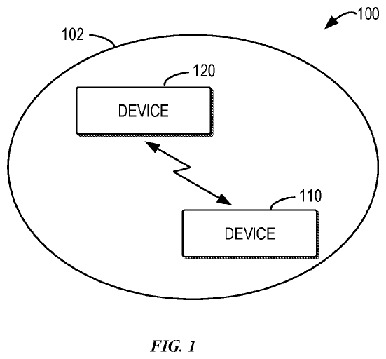

FIG. 1 illustrates an example communication environment 100 in which example embodiments of the present disclosure can be implemented. In the communication environment 100, a plurality of communication devices, including a device 110 (also referred to as “first device”) and a device 120 (also referred to as “second device”), can communicate with each other.

In the example of FIG. 1, the device 110 may include a terminal device and the device 120 may include a network device serving the terminal device. The serving area of the device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the device 120 may be another device than a network device. Although illustrated as a terminal device, the device 110 may be another device than a terminal device.

In the following, for the purpose of illustration, some example embodiments are described with the device 110 operating as a terminal device and the device 120 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 120 is a network device, a link from the device 120 to the device 110 is referred to as a downlink (DL), while a link from the device 110 to the device 120 is referred to as an uplink (UL). In DL, the device 120 is a transmitting (TX) device (or a transmitter) and the device 110 is a receiving (RX) device (or a receiver). In UL, the device 110 is a TX device (or a transmitter) and the device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure will be described in detail below with reference to the accompanying drawings. Example embodiments of the present disclosure may be applied to beam failure detection scenario. Alternatively, example embodiments of the present disclosure may be applied to radio link monitor (RLM) scenario.

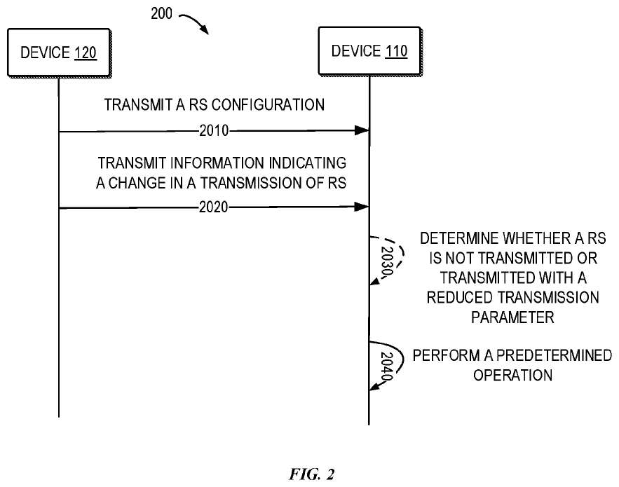

Reference is now made to FIG. 2, which shows a signaling chart 200 for communication according to some example embodiments of the present disclosure. As shown in FIG. 2, the signaling chart 200 involves a device 110 and a device 120. For the purpose of discussion, reference is made to FIG. 1 to describe the signaling chart 200. Although one device 110 and one device 120 are illustrated in FIG. 2, it would be appreciated that there may be a plurality of first device performing similar operations as described with respect to the first device 110 below and a plurality of third device performing similar operations as described with respect to the device 120 below.

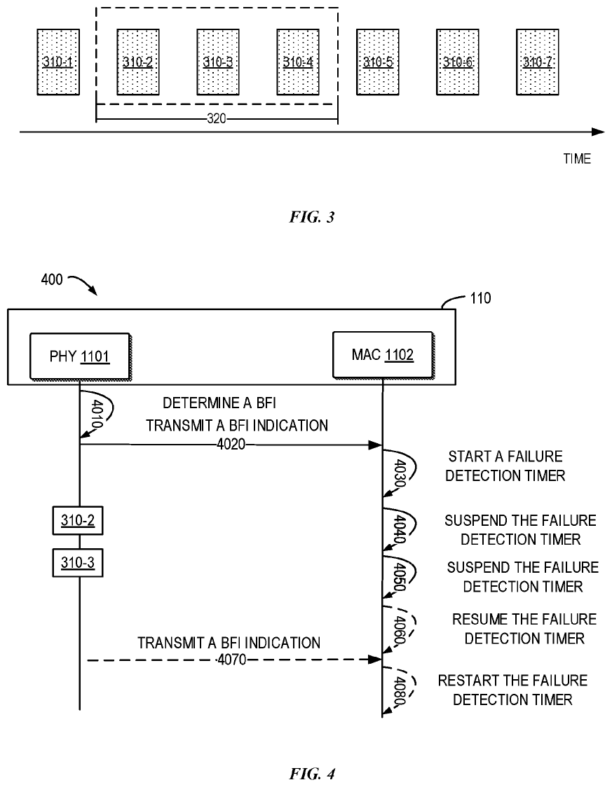

The device 120 transmits 2010 a reference signal configuration to the device 110. The reference signal configuration indicates a set of occasions for monitoring a set of reference signals. The term “occasion” used herein can refer to a time domain and frequency domain resource where a reference signal can be transmitted. For example, as shown in FIG. 3, the reference signal configuration may indicate the occasions 310-1, 310-2, 310-3, 310-4, 310-5, 310-6, and 310-7 where the set of reference signals may be transmitted. In this case, the device 110 may monitor reference signals in the occasions 310-1, 310-2, 310-3, 310-4, 310-5, 310-6, and 310-7. It is noted that the number of occasions shown in FIG. 3 is only an example not limitation. In some example embodiments, the reference signal configuration may be configured via a higher layer parameter. The reference signal configuration may also a periodicity of the reference signal. In some example embodiments, the reference signal configuration may be transmitted to the device 110 via a dedicated signaling.

In some example embodiments, the reference signal may refer to a beam failure detection reference signal (BFD-RS). For example, the BFD-RS may include a CSI-RS. In this case, for example, a set of CSI-RS resources may be configured as the set of occasions. Alternatively, or in addition, the BFD-RS may include a synchronization signal/physical broadcast channel block (SSB).

Alternatively, the reference signal may refer to a radio link monitoring reference signal (RLM-RS). For example, the RLM-RS may include a CSI-RS. In this case, for example, a set of CSI-RS resources may be configured as the set of occasions. Alternatively, or in addition, the RLM-RS may include a synchronization signal/physical broadcast channel block (SSB).

The device 120 transmits 2020 information indicating a change in a transmission of the reference signal to the device 110. For example, if the device 120 enters DTX mode, the device 120 may transmit the information indicating its DTX status to the device 110. In some example embodiments, the information indicating the change may be broadcasted. For example, the information indicating the change may be cell specific. In some example embodiments, the information indicating the change may be transmitted via downlink control information. In this way, since the device 110 receives the reference signal configuration and the information indicating the change (for example, DTX status), the device 110 may take both the reference signal configuration and the DTX status into account, thereby avoiding frequent radio resource control (RRC) reconfiguration to update the reference signal configuration reflecting the DTX status to each terminal device.

In some example embodiments, the information may indicate that a reference signal is not transmitted. Alternatively, the information may indicate that the reference signal is transmitted with a reduced transmission parameter. The term “reduced transmission parameter” used herein can refer a transmission parameter with smaller value compared with normal transmissions. In some example embodiments, the reduced transmission parameter may comprise a reduced number of antenna ports. For example, the number of antenna ports for normal transmission may be 4 and the reduced number of antenna ports may be 2. Alternatively, or in addition, the reduced transmission parameter may comprise a reduced transmission power. For example, the transmission power for normal transmission may be value X and the reduced transmission power may be value X/2. In some example embodiments, the reduced transmission parameter may comprise a reduce resource, for example, a reduced time domain resource or a reduced frequency domain resource. For example, the number of resource blocks (RB) for normal transmission may be Y and the reduced number of RB may be Y/2.

The device 110 may monitor reference signals in the occasions 310-1, 310-2, 310-3, 310-4, 310-5, 310-6 and 310-7. The device 110 may also perform a measurement on the reference signals. For example, the device 110 may measure a reference signal received power (RSRP) on the reference signals.

The device 110 may determine 2030 whether a reference signal is not transmitted in an occasion from the set of occasions. Alternatively, the first device 110 may determine 2030 whether the reference signal is transmitted with a reduced transmission power in the occasion from the set of occasions. As shown in FIG. 3, since the occasions 310-2, 310-3 and 310-4 overlap with a sleeping duration 320 of the device 120, there may be no signal transmitted in the occasions 310-2, 310-3 and 310-4. Alternatively, the signals may be transmitted in the occasions 310-2, 310-3 and 310-4 with the reduced transmission parameter.

The device 110 performs 2040 a predetermined operation associated with a failure detection, if a reference signal is not transmitted or transmitted in a reduced transmission parameter in one or more occasions from the set of occasions. In some example embodiments, the device 110 may determine whether a failure detection timer is running. For example, if a beam failure instance (BFI) is detected in the occasion 310-1, the device 110 may start the failure detection timer. The term “beam failure instance” used herein can refer to an occurrence/detection of the beam failure. If the failure detection timer is running, the device 110 may suspend running of the failure detection timer. For example, since the occasions 310-2, 310-3 and 310-4 overlap with a sleeping duration 320 of the device 120, the device may suspend running of the failure detection timer at the occasions 310-2, 310-3 and 310-4. In some example embodiments, since the occasions 310-2, 310-3 and 310-4 overlap with a sleeping duration 320 of the device 120, the device 110 may perform the action of suspension at the occasion 310-2. By way of example, if no reference signal is received or the RSRP of the received reference signal is below a RSRP threshold in the occasions 310-2, 310-3 and 310-4, the PHY layer of the device 110 may not transmit a beam failure instance (BFI) indication to the MAC layer of the device 110. In this case, the MAC layer of the device 110 may suspend the running of the failure detection timer. In Ii this way, it may avoid false alarm failure declaration to not indicate failure indication when the reference signal is not sent due to DTX for power saving.

In some example embodiments, the device 110 may determine that a reference signal is transmitted on another occasion after the one or more occasions. The device 110 may also determine whether the running of the failure detection timer is suspended. In this case, if the running of the failure detection timer is suspended, the device 110 may resume the failure detection timer. For example, if the device 110 receives a reference signal in the occasion 310-5, the device 110 may determine whether the running of the failure detection timer is suspended. If the running of the failure detection timer is suspended, the device 110 may resume the failure detection at the occasion 310-5. In this way, it may avoid false reset of failure detection counter by suspending the timer when no failure indication is received due to no reference signal is sent.

Alternatively, if the reference signal is not transmitted or transmitted in the reduced transmission parameter in the occasion from the set of occasions, the device 110 may determine a failure instance in the occasion. The device 110 may not increase the value of a failure counter. The device 110 may also restart the failure detection timer based on the failure instance. For example, if no signal is transmitted in the occasion 310-2, the PHY layer of the device 110 may determine a failure instance. The PHY layer of the device 110 may transmit a failure instance indication to the MAC layer of the device 110. In this case, the MAC layer of the device 110 may not increase the value of the failure counter and restart the failure detection timer based on the failure instance. In this way, it may avoid false reset of failure detection counter.

In some other example embodiments, if the reference signal is not transmitted or transmitted in the reduced transmission parameter in the occasion from the set of occasions, the device 110 may determine to reset the failure counter. For example, the failure counter or BFI_COUNTER may be set to value 0. In this way, the MAC layer may reset the failure detection procedure in case the reference signal is not transmitted or transmitted in the reduced transmission parameter in the occasion from the set of occasions.

In some other example embodiments, the device 110 may increase a number threshold of the failure counter to a target number threshold. If the reference signal is not transmitted or transmitted in the reduced transmission parameter in the occasion from the set of occasions, the device 110 may determine a failure instance in the occasion. The device 110 may increase the value of the failure counter. The device 110 may also restart the failure detection timer based on the failure instance. In this case, the device 110 may determine whether a failure is declared based on the target number threshold of the failure counter and a value of the failure counter. For example, if no signal is transmitted in the occasion 310-2, the PHY layer of the device 110 may determine a failure instance. The PHY layer of the device 110 may transmit a failure instance indication to the MAC layer of the device 110. In this case, the MAC layer of the device 110 may increase the value of the failure counter and restart the failure detection timer based on the failure instance. The MAC layer of the device may determine whether the failure is declared based on the target number threshold of the failure counter and the value of the failure counter. In this way, it may avoid false reset of failure detection counter.

Alternatively, the device 110 may determine whether a failure detection timer is running. For example, if a beam failure instance (BFI) is detected in the occasion 310-1, the device 110 may start the failure detection timer. If the failure detection timer is running, the device 110 may maintain running of the failure detection timer based on an extended running time. In some example embodiments, the device 110 may determine the extended running time based on a periodicity of transmitting the reference signal. For example, the device 110 may determine the extended running time based on the time between a reference signal occasion where it is transmitted and the next reference signal occasion where it is transmitted. For example, if no signal is transmitted in the occasion 310-2, the PHY layer of the device 110 may determine a failure instance. The PHY layer of the device 110 may not transmit a failure instance indication to the MAC layer of the device 110. In this case, the MAC layer of the device 110 may not increase the value of the failure counter and maintain running of the failure detection timer based on the extended running time. By way of example, a DTX pattern may be configured as extending the configured BFD-RS periodicity to a number times (for example, 2, 4, 8 and the like) of original configured value. In this case, the failure detection timer value may be scaled accordingly when the corresponding gNB DTX is enabled or activated. In other words, the failure detection timer may only count BFD-RS periods regardless of the periodicity (which depends on the DTX). In this way, it may avoid false alarm failure declaration by extending the running time.

According to example embodiments of the present disclosure, it can avoid false alarm of beam failure declaration or false reset of the counter due to absence of reference signal when the network decides not to send them for power saving. Moreover, it avoids false alarm BFD declaration to not indicate BFI when BFD-RS is not sent due to DTX for power saving. Additionally, it avoids false reset of BFD counter by suspending the timer when no BFI is received due to no BFD-RS is sent.

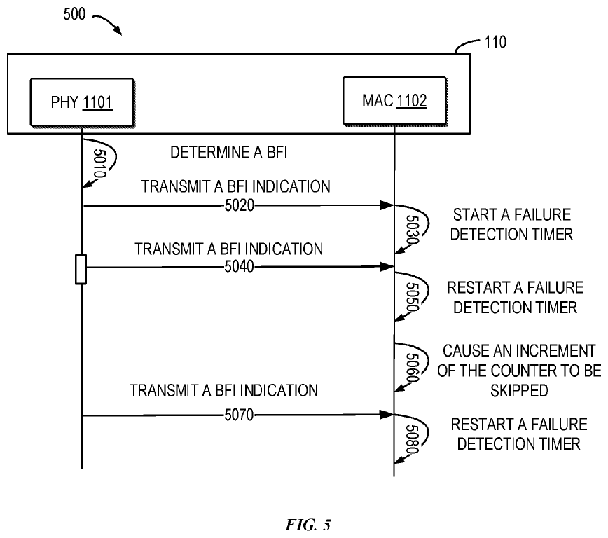

Some example embodiments of the present disclosure are described with reference to FIGS. 4-7. It is noted that embodiments described with reference to FIGS. 4-7 are only examples not limitations.

Reference is now made to FIG. 4, which shows a signaling chart 400 for communication according to some example embodiments of the present disclosure. As shown in FIG. 4, the signaling chart 400 involves a PHY layer 1101 and a MAC layer 1102 at the device 110. According to example embodiments of FIG. 4, it avoids false alarm BFD declaration to not indicate BFI when BFD-RS is not sent due to DTX for power saving.

The PHY layer 1101 may determine 4010 a BFI based on the RSRP of the reference signal, for example, if the RSRP of reference signal is below a RSRP threshold. The PHY layer 1101 may transmit 4020 a BFI indication to the MAC layer 1102. The MAC layer 1102 may start 4030 a failure detection timer based on the BFI indication.

If there is no signal transmitted in the occasions 310-2, 310-3 and 310-4 due to overlapping with the DTX period, the PHY layer 1101 may not indicate the BFI to the MAC layer 1102. In this case, the MAC layer 1102 may suspend 4040 the failure detection timer at the occasion 310-2. The MAC layer 1102 may also suspend 4050 the failure detection timer at the occasion 310-3. The failure detection timer may be kept suspending after the occasion 310-3. At the first occasion when the reference signal is sent outside of the DTX period, for example, at the occasion 310-5, if no BFI is received, the MAC layer 1102 may resume 4060 the failure detection timer. Alternatively, at the first occasion when the reference signal is sent outside of the DTX period, for example, at the occasion 310-5, the PHY layer 1101 may transmit 4070 an BFI indication to MAC layer 1102 if the RSRSP of the received reference signal is below a RSRP threshold. In this case, the MAC layer 1102 may restart 4080 the failure detection timer. The MAC layer 1102 may also increase the BFD counter.

Reference is now made to FIG. 5, which shows a signaling chart 500 for communication according to some example embodiments of the present disclosure. As shown in FIG. 5, the signaling chart 500 involves a PHY layer 1101 and a MAC layer 1102 at the device 110. According to example embodiments of FIG. 5, it avoids false reset of the counter.

The PHY layer 1101 may determine 5010 a BFI based on the RSRP of the reference signal. The PHY layer 1101 may transmit 5020 a BFI indication to the MAC layer 1102. The MAC layer 1102 may start 5030 a failure detection timer based on the BFI indication.

If there is no signal transmitted in the occasion due to overlapping with the DTX period, the PHY layer 1101 may determine a BFI and transmit 5040 an BFI indication to the MAC layer 1102. In this case, the MAC layer 1102 may restart 5050 the failure detection timer. The MAC layer 1102 may cause 5060 an increment of the counter to be skipped. In other words, the MAC layer 1102 may not increase the counter. The MAC layer 1102 may ignore the BFI indication. At the first occasion when the reference signal is sent outside of the DTX period, for example, at the occasion 310-5, the PHY layer 1101 may transmit 5070 a BFI indication to the MAC layer 1102 outside the DTX period if the RSRSP of the received reference signal is below a RSRP threshold. In this case, the MAC layer 1102 may restart 5080 the failure detection timer. The MAC layer 1102 may also increase the counter. Alternatively, at the first occasion when the reference signal is sent outside of the DTX period, for example, at the occasion 310-5, the PHY layer 1101 may not transmit a BFI indication to the MAC layer 1102 outside the DTX period if the RSRSP of the received reference signal is above a RSRP threshold. In this case, the MAC layer 1102 may continue running the failure detection timer. In this way, it may avoid frequent RRC reconfiguration with taking both the reference signal configuration and the DTX pattern into account.

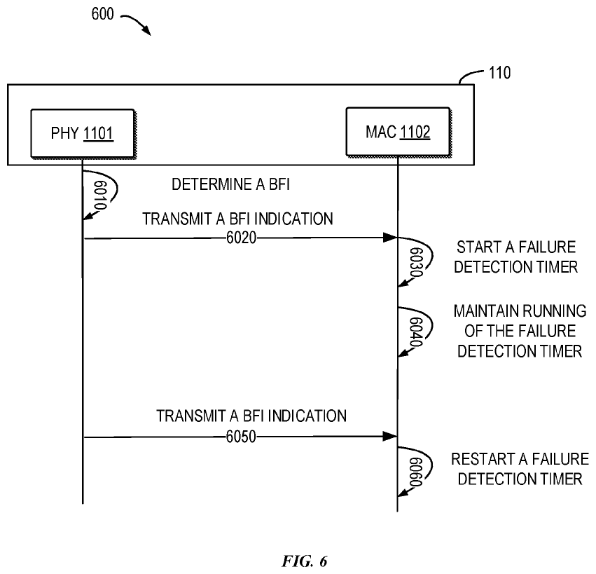

Reference is now made to FIG. 6, which shows a signaling chart 600 for communication according to some example embodiments of the present disclosure. As shown in FIG. 6, the signaling chart 600 involves a PHY layer 1101 and a MAC layer 1102 at the device 110. According to example embodiments of FIG. 6, it avoids false alarm BFD declaration to not indicate BFI when BFD-RS is not sent due to DTX for power saving.

The PHY layer 1101 may determine 6010 a BFI based on the RSRP of the reference signal. The PHY layer 1101 may transmit 6020 a BFI indication to the MAC layer 1102. The MAC layer 1102 may start 6030 a failure detection timer based on the BFI indication. If there is no signal transmitted in the occasion due to overlapping with the DTX period, the MAC layer 1102 may not transmit a BFI indication to MAC layer and maintain 6040 the running of the failure detection timer based on an extended running time. In some example embodiments, the device 110 may determine the extended running time based on a periodicity of transmitting the reference signal. For example, the device 110 may determine the extended running time based on the time between a reference signal occasion where it is transmitted and the next reference signal occasion where it is transmitted. At the first occasion when the reference signal is sent outside of the DTX period, for example, at the occasion 310-5, the PHY layer 1101 may transmit 6050 a BFI indication to the MAC layer 1102 outside the DTX period if the RSRSP of the received reference signal is below a RSRP threshold. In this case, the MAC layer 1102 may restart 6060 the failure detection timer. The MAC layer 1102 may also increase the counter. Alternatively, at the first occasion when the reference signal is sent outside of the DTX period, for example, at the occasion 310-5, the PHY layer 1101 may not transmit a BFI indication to the MAC layer 1102 outside the DTX period if the RSRSP of the received reference signal is above a RSRP threshold. In this case, the MAC layer 1102 may continue running the failure detection timer.

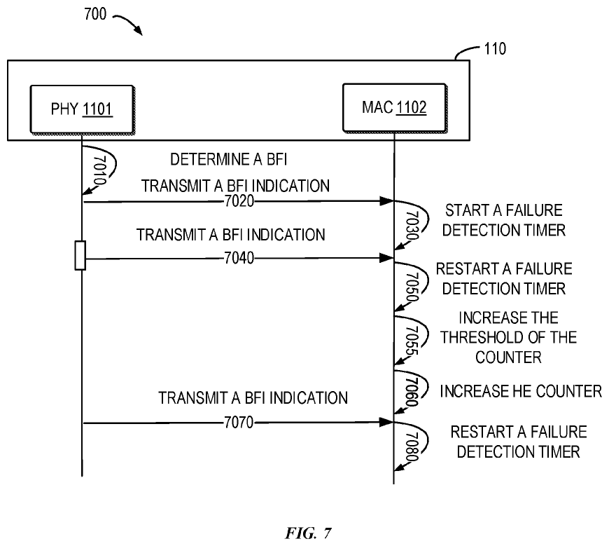

Reference is now made to FIG. 7, which shows a signaling chart 700 for communication according to some example embodiments of the present disclosure. As shown in FIG. 7, the signaling chart 700 involves a PHY layer 1101 and a MAC layer 1102 at the device 110. According to example embodiments of FIG. 7, it avoids false reset of the counter.

The PHY layer 1101 may determine 7010 a BFI based on the RSRP of the reference signal. The PHY layer 1101 may transmit 7020 a BFI indication to the MAC layer 1102. The MAC layer 1102 may start 7030 a failure detection timer based on the BFI indication.

If there is no signal transmitted in the occasion due to overlapping with the DTX period, the PHY layer 1101 may determine a BFI and transmit 7040 an BFI indication to the MAC layer 1102. In this case, the MAC layer 1102 may restart 7050 the failure detection timer. In some other example embodiments, the device 110 may increase a number threshold of the failure counter to a target number threshold. Only as an example, if the original threshold of the counter is 3 and there may be 3 occasions overlapped with the DTX period, the threshold number of the counter may be increased to 6 (i.e., the target number threshold). The MAC layer 1102 may increase 7060 the counter based on the BFI indication. In this case, if the value of the counter reaches the target number threshold, the device 110 may declare a beam failure. At the first occasion when the reference signal is sent outside of the DTX period for example, at the occasion 310-5, the PHY layer 1101 may transmit 7070 a BFI indication to the MAC layer 1102 outside the DTX period if the RSRSP of the received reference signal is below a RSRP threshold. In this case, the MAC layer 1102 may restart 7080 the failure detection timer. The MAC layer 1102 may also increase the counter. Alternatively, at the first occasion when the reference signal is sent outside of the DTX period for example, at the occasion 310-5, the PHY layer 1101 may not transmit a BFI indication to the MAC layer 1102 outside the DTX period if the RSRSP of the received reference signal is above a RSRP threshold. In this case, the MAC layer 1102 may continue running the failure detection timer.

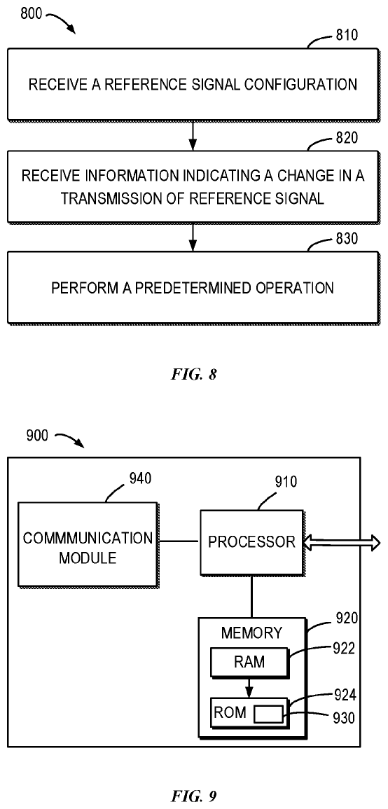

FIG. 8 shows a flowchart of an example method 800 implemented at a first device in accordance with some example embodiments of the present disclosure. For the purpose of discussion, the method 800 will be described from the perspective of the device 110 in FIG. 1.

At block 810, the device 110 receives a reference signal configuration from the device 120. The reference signal configuration indicates a set of occasions for monitoring a set of reference signals. In some example embodiments, the reference signal configuration may be configured via a higher layer parameter. The reference signal configuration may also a periodicity of the reference signal.

In some example embodiments, the reference signal may refer to a beam failure detection reference signal (BFD-RS). For example, the BFD-RS may include a CSI-RS. In this case, for example, a set of CSI-RS resources may be configured as the set of occasions. Alternatively, or in addition, the BFD-RS may include a synchronization signal/physical broadcast channel block (SSB).

Alternatively, the reference signal may refer to a radio link monitoring reference signal (RLM-RS). For example, the RLM-RS may include a CSI-RS. In this case, for example, a set of CSI-RS resources may be configured as the set of occasions. Alternatively, or in addition, the RLM-RS may include a synchronization signal/physical broadcast channel block (SSB).

At block 820, the device 110 receives information indicating a change in a transmission of the reference signal from the device 120. For example, if the device 120 enters DTX mode, the device 120 may transmit the information indicating its DTX status to the device 110. In some example embodiments, the information may indicate that a reference signal is not transmitted. Alternatively, the information may indicate that the reference signal is transmitted with a reduced transmission parameter. In some example embodiments, the reduced transmission parameter may comprise a reduced number of antenna ports. For example, the number of antenna ports for normal transmission may be 4 and the reduced number of antenna ports may be 2. Alternatively, or in addition, the reduced transmission parameter may comprise a reduced transmission power. For example, the transmission power for normal transmission may be value X and the reduced transmission power may be value X/2. In some example embodiments, the reduced transmission parameter may comprise a reduce resource, for example, a reduced time domain resource or a reduced frequency domain resource. For example, the number of resource blocks (RB) for normal transmission may be Y and the reduced number of RB may be Y/2.

In some example embodiments, the device 110 may also perform a measurement on the reference signals. For example, the device 110 may measure a reference signal received power (RSRP) on the reference signals.

In some example embodiments, the device 110 may determine whether a reference signal is not transmitted in an occasion from the set of occasions. Alternatively, the first device 110 may determine whether the reference signal is transmitted with a reduced transmission power in the occasion from the set of occasions. In this way, it may avoid frequent RRC reconfiguration with taking both the reference signal configuration and the DTX pattern into account.

At block 830, the device 110 performs a predetermined operation associated with a failure detection, if a reference signal is not transmitted or transmitted in a reduced transmission parameter in one or more occasions from the set of occasions. In some example embodiments, the device 110 may determine whether a failure detection timer is running. If the failure detection timer is running, the device 110 may suspend running of the failure detection timer. In some example embodiments, a beam failure instance (BFI) indication may not be transmitted from a physical layer of the device 110 to a MAC layer of the device 110. In this way, it may avoid false alarm failure declaration to not indicate failure indication when the reference signal is not sent due to DTX for power saving.

In some example embodiments, the device 110 may determine that an other reference signal is transmitted on another occasion after the one or more occasions. The device 110 may also determine whether the running of the failure detection timer is suspended. In this case, if the running of the failure detection timer is suspended, the device 110 may resume the failure detection. In this way, it may avoid false reset of failure detection counter by suspending the timer when no failure indication is received due to no reference signal is sent.

Alternatively, if the reference signal is not transmitted or transmitted in the reduced transmission parameter in the occasion from the set of occasions, the device 110 may determine a failure instance in the occasion. If the failure instance is determined, a BFI indication may be transmitted from a physical layer of the device 110 to a MAC layer of the device 110. The device 110 may not increase the value of a failure counter. The device 110 may also restart the failure detection timer based on the failure instance. In this way, it may avoid false reset of failure detection counter.

In some other example embodiments, the device 110 may increase a number threshold of the failure counter to a target number threshold. If the reference signal is not transmitted or transmitted in the reduced transmission parameter in the occasion from the set of occasions, the device 110 may determine a failure instance in the occasion. If the failure instance is determined, a BFI indication may be transmitted from a physical layer of the device 110 to a MAC layer of the device 110. The device 110 may increase the value of the failure counter based on the failure instance indication. The device 110 may also restart the failure detection timer based on the failure instance indication. In this case, the device 110 may determine whether a failure is declared based on the target number threshold of the failure counter and a value of the failure counter. In this way, it may avoid false reset of failure detection counter.

Alternatively, the device 110 may determine whether a failure detection timer is running. If the failure detection timer is running, the device 110 may maintain running of the failure detection timer based on an extended running time. In some example embodiments, the device 110 may determine the extended running time based on a periodicity of transmitting the reference signal. For example, the device 110 may determine the extended running time based on the time between a reference signal occasion where it is transmitted and the next reference signal occasion where it is transmitted. For example, if no signal is transmitted in the occasion, the PHY layer of the device 110 may determine a failure instance. The PHY layer of the device 110 may skip to transmit a failure instance indication to the MAC layer of the device 110. In this case, the MAC layer of the device 110 may maintain running of the failure detection timer based on the extended running time. By way of example, a DTX pattern may be configured as extending the configured BFD-RS periodicity to a number times (for example, 2, 4, 8 and the like) of original configured value. In this case, the failure detection timer value may be scaled accordingly when the corresponding gNB DTX is enabled or activated. In other words, the failure detection timer may only count BFD-RS periods regardless of the periodicity (which depends on the DTX). In this way, it may avoid false alarm failure declaration.

In some example embodiments, a first apparatus capable of performing any of the method 800 (for example, the first device 110 in FIG. 1) may comprise means for performing the respective operations of the method 800. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a second apparatus, a reference signal configuration indicating a set of occasions for monitoring a set of reference signals; means for receiving, from the second device, information indicating a change in a transmission of a reference signal; and means for in accordance with a determination that the reference signal is not transmitted or transmitted with a reduced transmission parameter in an occasion from the set of occasions based on the information, performing a predetermined operation associated with a failure detection.

In some example embodiments, the information indicates at least one of: the reference signal not transmitted, or the reference signal transmitted with the reduced transmission parameter.

In some example embodiments, the reduced transmission parameter comprises at least one of: a reduced number of antenna power, a reduced transmission power, a reduced time domain resource, or a reduced frequency domain resource.

In some example embodiments, the means for performing the predetermined operation comprises: means for determining that a failure detection timer is running; and means for based on determining that the failure detection timer is running, suspending running of the failure detection timer.

In some example embodiments, the first apparatus comprises means for causing a transmission of failure instance indication from a physical layer of the first device to a medium access control layer of the first device to be skipped.

In some example embodiments, the first apparatus comprises means for determining that another reference signal is transmitted in another occasion after the occasion; means for determining that running of a failure detection timer is suspended; and means for based on determining that the running of the failure detection timer is suspended, resuming the failure detection timer.

In some example embodiments, the means for performing the predetermined operation comprises: means for determining a failure instance; means for transmitting a failure instance indication from a physical layer of the first device to a medium access control layer of the first device; means for causing an increment of a failure counter to be skipped; and means for restarting a failure detection timer based on the failure instance indication.

In some example embodiments, the means for performing the predetermined operation comprises: means for increasing a number threshold of the failure counter to a target number threshold; means for determining a failure instance; means for transmitting a failure instance indication from a physical layer of the first device to a medium access control layer of the first device; means for increasing a failure counter based on the failure instance indication; means for restarting a failure detection timer; and means for determining whether a failure is detected based on the target number threshold of the failure counter and a value of the failure counter.

In some example embodiments, the means for performing the predetermined operation comprises: means for determining that a failure detection timer is running; and means for based on determining that the failure detection timer is running, maintaining running of the failure detection timer based on an extended running time.

In some example embodiments, the first apparatus comprises means for determining the extended running time based on a periodicity of transmitting the reference signal.

In some example embodiments, the failure detection comprises one of: a beam failure detection, or a radio link failure detection in radio link monitoring.

In some example embodiments, the first apparatus comprises a terminal device, and the second apparatus comprises a network device.

FIG. 9 is a simplified block diagram of a device 900 that is suitable for implementing example embodiments of the present disclosure. The device 900 may be provided to implement a communication device, for example, the device 110 or the device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

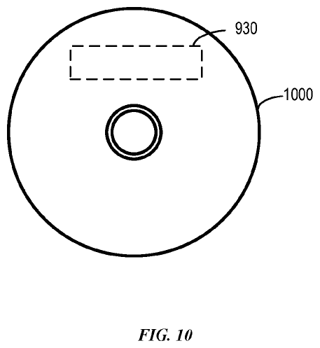

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-26. (canceled)

27. A first device comprising:
at least one processor; and
at least one memory storing instructions that, when executed by the at least one processor, cause the first device at least to perform:
receiving, from a second device, a reference signal configuration indicating a set of occasions for monitoring a set of reference signals;
receiving, from the second device, information indicating a change in a transmission of a reference signal of the set of reference signals; and
in accordance with a determination that the reference signal is not transmitted or transmitted with a reduced transmission parameter in an occasion from the set of occasions based on the information, performing a predetermined operation associated with a failure detection.

28. The first device of claim 27, wherein the information indicates at least one of:
the reference signal not transmitted, or
the reference signal transmitted with the reduced transmission parameter.

29. The first device of claim 27, wherein the reduced transmission parameter comprises at least one of:
a reduced number of antenna power,
a reduced transmission power,
a reduced time domain resource, or
a reduced frequency domain resource.

30. The first device of claim 27, wherein performing the predetermined operation comprises:
determining that a failure detection timer is running; and
based on determining that the failure detection timer is running, suspending running of the failure detection timer.

31. The first device of claim 30, wherein the first device is further caused to perform:
causing a transmission of beam failure instance indication from a physical layer of the first device to a medium access control layer of the first device to be skipped.

32. The first device of claim 27, wherein the first device is further caused to perform:
determining that another reference signal is transmitted in another occasion after the occasion;
determining that running of a failure detection timer is suspended; and
based on determining that the running of the failure detection timer is suspended, resuming the failure detection timer.

33. The first device of claim 27, wherein performing the predetermined operation comprises:
determining a failure instance;
transmitting a beam failure instance indication from a physical layer of the first device to a medium access control layer of the first device;
causing an increment of a failure counter to be skipped; and
restarting a failure detection timer based on the failure instance indication.

34. The first device of claim 27, wherein performing the predetermined operation comprises:
increasing a number threshold of the failure counter to a target number threshold;
determining a failure instance;
transmitting a beam failure instance indication from a physical layer of the first device to a medium access control layer of the first device;
increasing a failure counter based on the failure instance indication;
restarting a failure detection timer; and
determining whether a failure is detected based on the target number threshold of the failure counter and a value of the failure counter.

35. The first device of claim 27, wherein performing the predetermined operation comprises:
determining that a failure detection timer is running; and
based on determining that the failure detection timer is running, maintaining running of the failure detection timer based on an extended running time.

36. The first device of claim 35, wherein the first device is further caused to perform:
determining the extended running time based on a periodicity of transmitting the reference signal.

37. The first device of claim 27, wherein the failure detection comprises one of:
a beam failure detection, or
a radio link failure detection in radio link monitoring.

38. The first device of claim 27, wherein the first device comprises a terminal device, and the second device comprises a network device.

39. A method comprising:
receiving, from a second device, a reference signal configuration indicating a set of occasions for monitoring a set of reference signals;
receiving, from the second device, information indicating a change in a transmission of a reference signal of the set of reference signals; and
in accordance with a determination that the reference signal is not transmitted or transmitted with a reduced transmission parameter in an occasion from the set of occasions based on the information, performing a predetermined operation associated with a failure detection.

40. The method of claim 39, wherein the information indicates at least one of:
the reference signal not transmitted, or
the reference signal transmitted with the reduced transmission parameter.

41. The method of claim 39, wherein the reduced transmission parameter comprises at least one of:
a reduced number of antenna power,
a reduced transmission power,
a reduced time domain resource, or
a reduced frequency domain resource.

42. The method of claim 39, wherein performing the predetermined operation comprises:
determining that a failure detection timer is running; and
based on determining that the failure detection timer is running, suspending running of the failure detection timer.

43. The method of claim 42, further comprising:
causing a transmission of failure instance indication from a physical layer of the first device to a medium access control layer of the first device to be skipped.

44. The method of claim 39, further comprising:
determining that another reference signal is transmitted in another occasion after the occasion;
determining that running of a failure detection timer is suspended; and
based on determining that the running of the failure detection timer is suspended, resuming the failure detection timer.

45. The method of claim 39, wherein performing the predetermined operation comprises:
determining a failure instance;
transmitting a failure instance indication from a physical layer of the first device to a medium access control layer of the first device;
causing an increment of a failure counter to be skipped; and
restarting a failure detection timer based on the failure instance indication.

46. The method of claim 39, wherein performing the predetermined operation comprises:
increasing a number threshold of the failure counter to a target number threshold;
determining a failure instance;
transmitting a failure instance indication from a physical layer of the first device to a medium access control layer of the first device;
increasing a failure counter based on the failure instance indication;
restarting a failure detection timer; and
determining whether a failure is detected based on the target number threshold of the failure counter and a value of the failure counter.
